(19) United States
(12) Patent Application Publication
(10) Pub. No.: US 2003/0097650 A1
(43) Pub. Date: May 22, 2003

(54) Method and apparatus for testing software

(75) Inventors: Peter C. Bahrs, Austin, TX (US); Raphael P. Chancey, Austin, TX (US); Brian Thomas Lillie, Austin, TX (US); Michael Ray Olivas, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/970,869

(22) Filed: Oct. 4, 2001

(51) Int. Cl. G06F 9/44

(52) U.S. Cl. 717/124

(57) ABSTRACT

A method, apparatus, and computer instructions for testing software. A software component is loaded onto a data processing system. Input data is read from a configuration data structure for a test case. The software component is executed using the test case in which an actual result is generated. The actual result is compared with an expected result.

### BACKGROUND OF THE INVENTION

1. Technical Field

The present invention relates generally to an improved data processing system, and in particular to a method and apparatus for testing software. Still more particularly, the present invention provides a method and apparatus for testing different software components using a common application testing framework.

2. Description of Related Art

In developing software products, testing software is an essential part of the process of software product development. Software developers employ a variety of techniques to test software for performance and errors. Often the software is tested at a “beta” test site; that is, the software developer enlists the aid of outside users to test the new software. The users use the beta test software and report on any errors found in the software. Beta testing requires large amounts of time from many users to determine whether any errors remain. Typically, a developer will select many beta test sites because if only a few beta test sites are used, the testing process consumes long periods of time because the small numbers of users are less likely to uncover errors than a large group of testers using the software in a variety of applications. As a result, software developers generally use a large number of beta test sites to reduce the time required for testing the software. Identifying errors reported through beta testing may often take time to correct if the beta tests are conducted on different computer architectures. In addition, beta testing is primarily focused on the externals of the software, such as, does the presentation show the correct details, or if this input is entered, is this output returned. Beta testing does not usually permit testing of the internals of the software.

Other software developers utilize automatic software testing in order to reduce the cost and time for software testing. In a typical automatic software testing system, the software is run through a series of predetermined commands until an error is detected. Upon detecting an error, the automated test system will generally halt or write an entry into a log. This type of testing provides an advantage over beta testing because the conditions under which the software is tested may be controlled. A disadvantage to this type of testing is that the testing software is developed for a particular component. Thus, when another software application is developed, new testing software must be generated to test this software application. Having to develop testing software for each application or component is a time consuming and expensive process. This approach may permit more rigorous testing of the software internals, but still requires unique testing code for each component.

Therefore, it would be advantageous to have an improved method, apparatus, and computer instructions for testing software in which the same test mechanism may be used for many different software components.

### SUMMARY OF THE INVENTION

The present invention provides a method, apparatus, and computer instructions for testing software. A software component is loaded onto a data processing system. Input data is read from a configuration data structure for a test case. The software component is executed using the test case in which an actual result is generated. The actual result is compared with an expected result. If necessary, metrics calculated during the test case execution can be displayed.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a flowchart of a process for developing a software product in accordance with a preferred embodiment of the present invention;

FIG. 4 is a diagram illustrating an architecture used for testing application components in accordance with a preferred embodiment of the present invention;

FIG. 5 is a diagram of classes in an application testing framework in accordance with a preferred embodiment of the present invention;

FIG. 6 is a flowchart of a process used for testing a component in accordance with a preferred embodiment of the present invention;

FIG. 7 is a flowchart of a process used for executing a test case in accordance with a preferred embodiment of the present invention;

FIG. 8 is a diagram illustrating example attributes associated with a test harness in accordance with a preferred embodiment of the present invention;

FIG. 9 is a diagram illustrating example attributes associated with an abstract test mediator in accordance with a preferred embodiment of the present invention;

FIG. 10 is a diagram illustrating a hierarchy of test case classes in accordance with a preferred embodiment of the present invention;

FIG. 11 is a diagram illustrating example attributes for an abstract test case class in accordance with a preferred embodiment of the present invention;

FIG. 12 is a flowchart of a process for generating test code using a reflection function in accordance with a preferred embodiment of the present invention; and

FIG. 13 is a flowchart of a process used for comparing test results in accordance with a preferred embodiment of the present invention.

### DETAILED DESCRIPTION OF THE PREFERRED EMBODIMENT

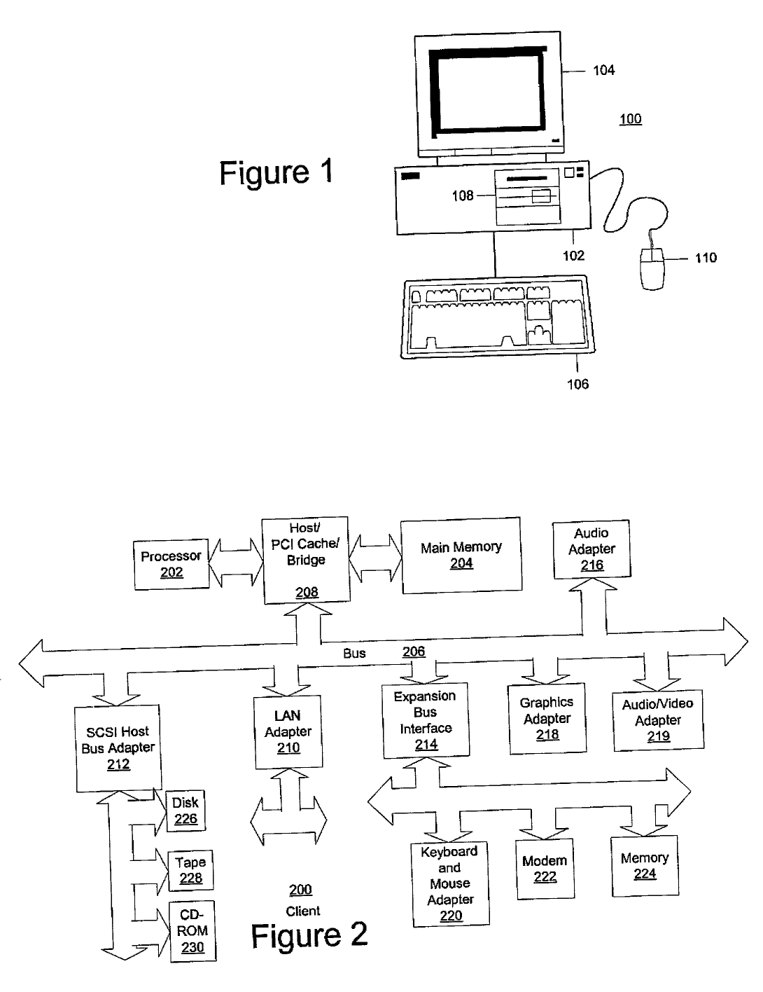

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface.

The depicted example in FIG. 2 and above-described examples are not meant to imply architectural limitations. For example, data processing system 200 also may be a notebook computer or hand held computer.

The processes of the present invention are performed by processor 202 using computer implemented instructions, which may be located in a memory such as, for example, main memory 204, memory 224, or in one or more peripheral devices 226-230.

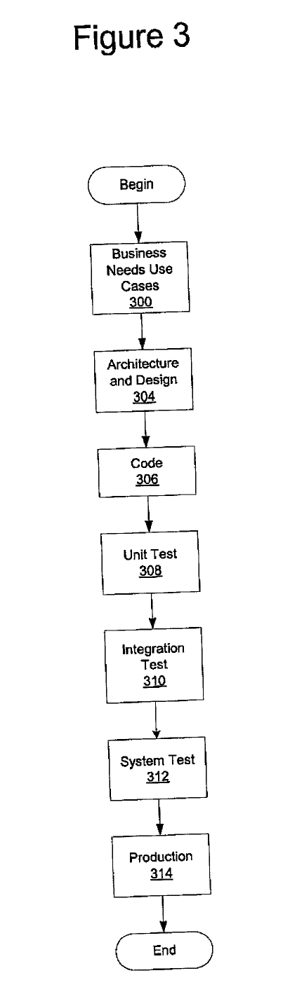

Turning next to FIG. 3, a flowchart of a process for developing a software product is depicted in accordance with a preferred embodiment of the present invention. The process illustrated in FIG. 3 is a process in which an application testing framework of the present invention may be applied.

The process begins by identifying needs of a business (step 300). This step involves identifying different cases in which the need is present. Then, architecture and design of a software application is performed to fit the need (step 304). Next, coding is performed for the software application (step 306). Afterwards, unit testing is performed (step 308), and integration testing is performed (step 310). Unit testing is generally conducted by the developer/creator of the code. Unit testing focuses on testing specific methods, with specific parameters, and verifying that each line of code performs as expected. From a Java perspective, unit testing is primarily focused on individual classes, and methods within the classes or even individual services, which for testing purposes (performance and error), can be considered a single unit. This framework was designed so individual services can be tested as a unit. Integration testing is where a multitude of classes forming larger components are combined with other components. System testing generally is conducted with all of the components of an application, including all vendor software, in an environment that is as complete as the production environment in which the application is expected to be used. System testing occurs thereafter (step 312).

After system testing has successfully occurred, then production of the software application begins (step 314) with the process terminating thereafter.

In many cases, after production, applications typically enter either one or both maintenance and enhancement phases. Applications undergoing enhancement may repeat the process of FIG. 3 starting from the beginning. Applications undergoing maintenance do not necessarily start at the beginning of the process in FIG. 3, but may pick up again with coding in step 306, and follow through with the process.

Also, while these are typical steps for most organizations, there are many other names that might be used for these steps. In addition, additional test steps may be used (such as performance testing). In all of these cases, the testing framework can be used.

The application testing framework of the present invention may be used during coding in step 306, unit testing in step 308, integration testing in step 310, system testing in step 312, and production in step 314.

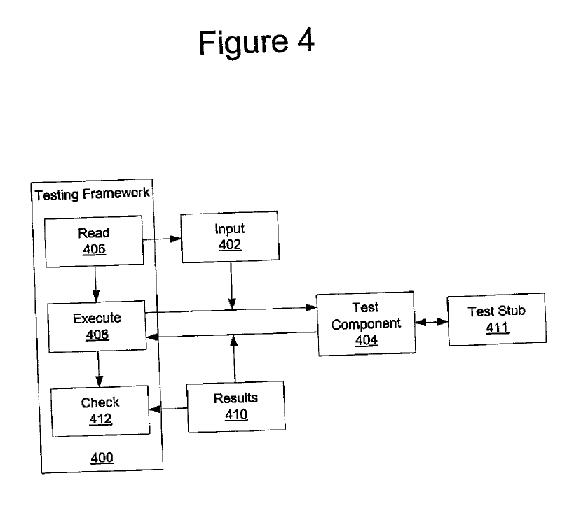

With reference next to FIG. 4, a diagram illustrating an architecture used for testing application components is depicted in accordance with a preferred embodiment of the present invention. Testing framework 400 is an example of an application testing framework, which may be used to test different software components. Testing framework 400 may be used to test many different types of software components without requiring rewriting of code for testing framework 400. Data for a test case forms input 402. This test case data includes the input and expected output data for testing test component 404. The input data and expected output data is read by read component 406 from input 402. Thereafter, execute component 408 executes test component 404 using the input data from input 402. Test component 404 generates results 410. In generating results 410, test component 404 may access test stub 411. In these examples, test stub 411 is used when either (a) the enterprise system to which the test component 404 normally connects is unavailable, or (b) specific data results need to be passed to test component 404. Depending upon the test case implementation, such as when logic is being tested, rather than outputs, test stub 411 may return the expected output data read from input 402.

Check component 412 compares results 410 to the expected results in input 402 to determine whether any errors are present. In these examples, the test case is only limited by the developer's imagination. The developer can embed specific metrics gathering code, external logging and tracing in the test case. The idea is to put as much reusable functionality in the test case as feasible for a particular software type. In these examples, input 402 is located in a configuration data structure, such as an extensible markup language (XML) file. The different components for testing framework 400 are implemented using an object-oriented programming language, such as Java. In these examples, the mechanism of the present invention also implements test component 404 using Java although other types of implementations may be used. By using Java, the mechanism of the present invention takes advantage of the reflection aspect of Java to generate code for use in testing that would have to be written by a developer. This is the code generation/instantiation aspect of the framework that helps make this testing framework of the present invention unique.

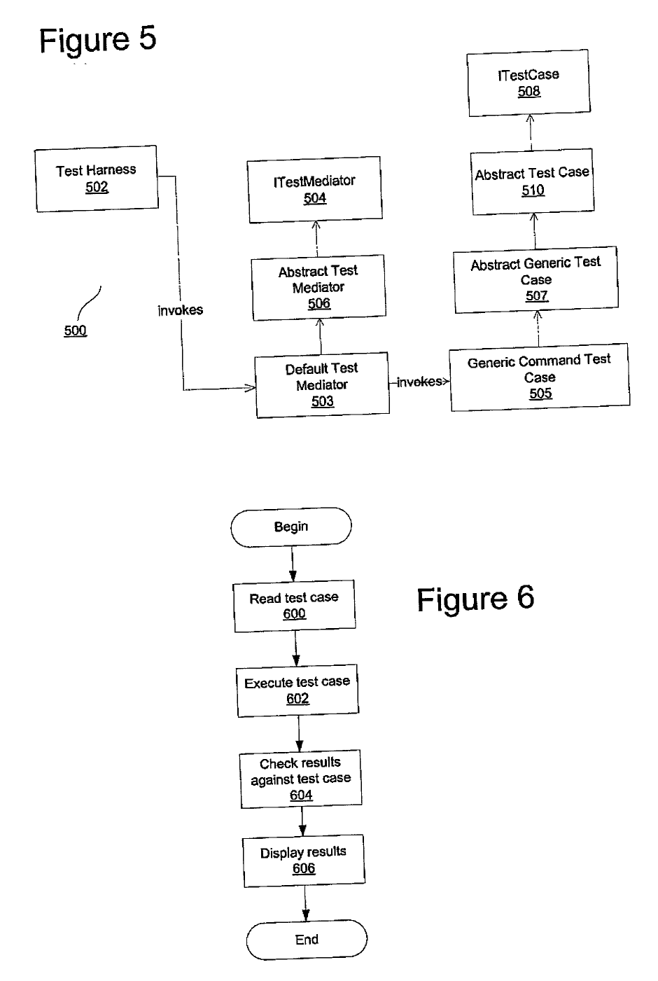

Turning next to FIG. 5, a diagram of classes in an application testing framework is depicted in accordance with a preferred embodiment of the present invention. The classes illustrated in application testing framework 500 are used in testing framework 400 in FIG. 4. With respect to this illustration, an interface is a contract—a list of methods or functions that are implemented to create an implementation—that is implemented by a class. A class contains fields and methods in which the methods contain the code that implements a class. A class that implements an interface—which meets the contract of the interface—also is said to be of the type of the interface. An abstract class may be an incomplete implementation of a class or may contain a complete default implementation for a class. Such a class must be extended to be used. All of the abstract classes described in these examples are designed to be extended for use.

Test harness 502 is an entry point in application testing framework 500. Test harness 502 is a highly configurable class used to drive the test execution. This component is the “engine” of the application testing framework 500 and is responsible for the following: (1) loading any configuration file(s); and (2) initializing, configuring and executing a test mediator, such as default test mediator 503, a subclass (extension) of the abstract test mediator 506, and an implementation of the ITestMediator 504.

The test harness class loads any configuration information it requires, initializes objects such as a test mediator based on the configuration information, and starts the testing execution. This class is responsible for setting up all threads, the number of iterations, metrics gathering, and throttling configurations within application testing framework 500. With respect to throttling, it is possible to configure throttling information such as testing framework execution duration (i.e. execute the framework for 36 hours), add meantime between test mediator executions (execute N test mediators with a mean wait time of 60 seconds between test mediator executions), add mean time between test case execution (execute a test case every 10 seconds), number of iterations of a test case per unit of time (execute 100 test cases every minute slowing the execution as necessary), and execute test cases at random intervals (test cases will be executed at random, theoretically simulating realistic arrivals of random events).

Abstract test mediator 506 is a complete working class in which a programmer may create subclasses to provide a more specific implementation. ITestMediator 504 is the interface for all test mediators. This interface offers a ‘contract’ that describes expected behavior for all implementers of this interface. Abstract test mediator 506 is a class that implements the ItestMediator interface and provides a set of default implementations for a behavior of a test mediator. Default test mediator 503 is a subclass of abstract test mediator 506 that can be instantiated and used by a developer. Abstract classes cannot be instantiated. A developer can also subclass abstract test mediator 506 to develop alternate specific behavior for a test mediator. In these examples, default test mediator 503 is provided as an example of a practical implementation for the application testing framework. Default test mediator 503 will invoke or execute a test case, such as generic command test case 505.

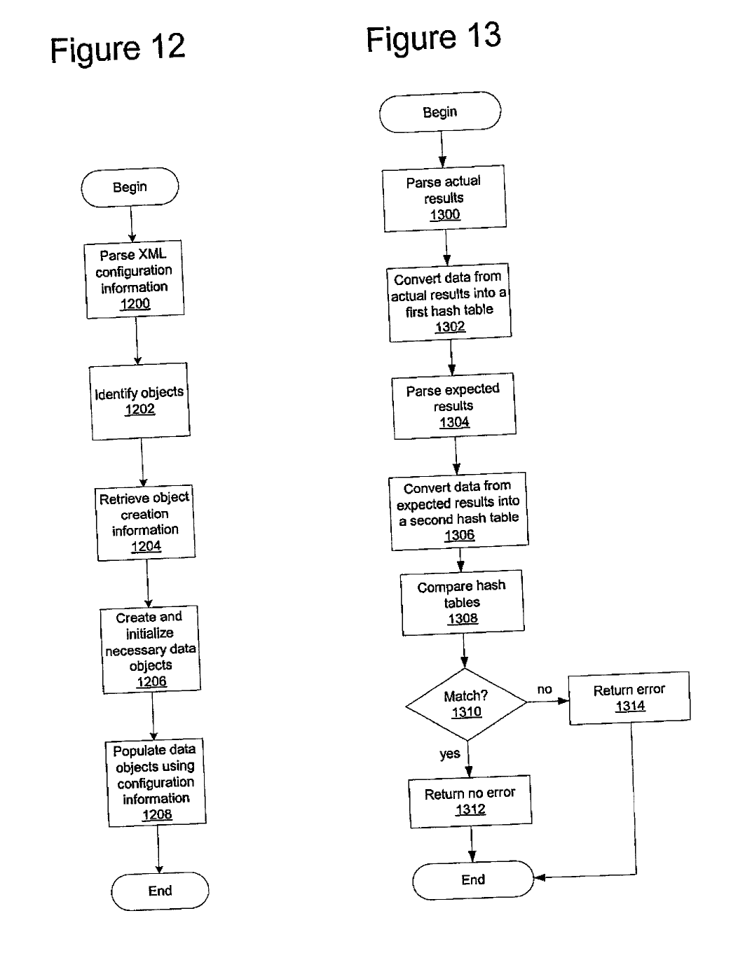

In this example, ITestCase 508 is the interface that offers a contract for a behavior for all test cases. This type of hierarchy is employed to allow the test mediator to maintain control of all test cases. For example, all test cases must have an execute method that the test mediator can invoke, so the interface guarantees that all test cases will provide an implementation of an execute method. Abstract test case 510 implements the ItestCase interface and provides some default behavior that is common among all test cases in the testing framework, such as an indicator of the passing or failure of the test case, or if the test case enabled. Abstract generic test case 507 is a subclass of abstract test case 510 that provides some default behavior that is specific to the ‘generic’ implementations of test cases, such as the reflection process of loading objects. This reflection process is described in more detail below in FIG. 12. This abstract class provides helper methods and exception handling behavior for loading and creating objects as needed. Generic command test case 505 is a subclass of abstract generic test case 507 and is an example of a generic test case that provides an implementation for testing all command objects. This particular subclass is an example of a subclass that may be developed or created by a developer. Generic command test case 505 is a subclass of the abstract test case and an implementation of ITestCase 508.

Default test mediator 503 initializes, configures, and executes test cases. This class is responsible for initializing, configuring, and mediating test case execution. More specifically, this class provides a mechanism to initialize and iterate over one or more test cases. Default test mediator 503 will pass data to the component being tested as a parameter. This class also maintains a cache used by the test cases to store data between test case executions. The test mediator is the actual “wrapper” around a test case set. The test mediator is executed each time the test harness requires execution of a test case set. The test mediator may execute a test case multiple times.

Test cases are used to invoke some logic on a particular application component, such as test component 404 in FIG. 4, being tested. This logic may be as simple as an execute method on a command, or a more elaborate mechanism where specific programmatic control is necessary. More specifically, each test case contains code which may be both generic to a software component and may be specific to a software component.

The functions provided by the test harness and the test mediator are provided for purposes of illustration and may be implemented into a combined component depending upon the particular implementation.

Application testing framework 500 is designed for configuring parameters and data control for individual test cases. This design allows for multiple iterations, data sets, and result sets to be configured without code modifications.

The granularity of the test case and the depth of its purpose may vary as needed. For example, a test case may be directed at exercising a given method of a given target object, or it can exercise an entire business function. Test cases are expected to make preparations for the execution of the test target, and then execute the target test components. The test target may be, for example, any number of objects, or business functions, but should equate roughly to a unit of work. Preparations may include, for example, creating objects, setting property values, loading parameters, and setting session states.

In these examples, two options may be provided within application testing framework 500. One option requires the developer/tester to build specific test cases for testing components. This means when a developer wishes to test an application component, the developer will build a test case object and insert code that handles the execution of that component. The developer is required to develop test case objects for each component that requires a unit test. Another option allows the developer to create an aggregate test case object that understands how to handle a component type. For example, a generic test case object may be built to handle enterprise access builder (EAB) commands, or a generic test case can be built to handle all record components.

With reference now to FIG. 6, a flowchart of a process used for testing a component is depicted in accordance with a preferred embodiment of the present invention. The process illustrated in FIG. 6 may be implemented in a test mediator, which is a subclass of abstract test mediator 506 in FIG. 5. In this example, the test case is located in an XML file and contains the data necessary to execute the component that is being tested.

The process begins by reading a test case (step 600). In these examples, the test case includes input data to be used in executing or testing the component as well as expected output data resulting from the execution or testing of the component. The test case is executed (step 602). In step 602, the test harness sends the appropriate commands or calls to the component being tested using the input data from the test case. The results are then checked against the test case (step 604). In these examples, the actual results generated from executing the test case are converted into a hash table, and the expected results are converted into a hash table. These two tables are compared to determine whether errors have occurred. Results are displayed (step 606) with the process terminating thereafter.

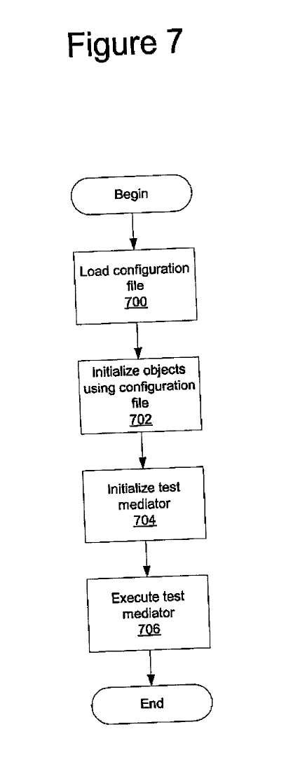

Turning next to FIG. 7, a flowchart of a process used for executing a test case is depicted in accordance with a preferred embodiment of the present invention. The process illustrated in FIG. 7 may be implemented in a test harness, such as test harness 502 in FIG. 5.

The process begins by loading a configuration file (step 700). In this example, the configuration file is located in the data structure, such as an XML file. Objects are initialized using the configuration file (step 702). The test mediator is initialized (step 704). The test mediator is executed (step 706) with the process terminating thereafter. When the test mediator is tested or invoked by the test harness on the test case, the test mediator will execute the test case(s). In these examples, more than one test case may be loaded and tested by the process. Additionally, the test harness will control the number of iterations required. For example, if five iterations are requested, then the test mediator is created or invoked five times by the test harness. Alternatively, the test harness may create a single test mediator and run the test five times. The control of iterations, as well as the throttling of the test, occurs within step 706 in these examples.

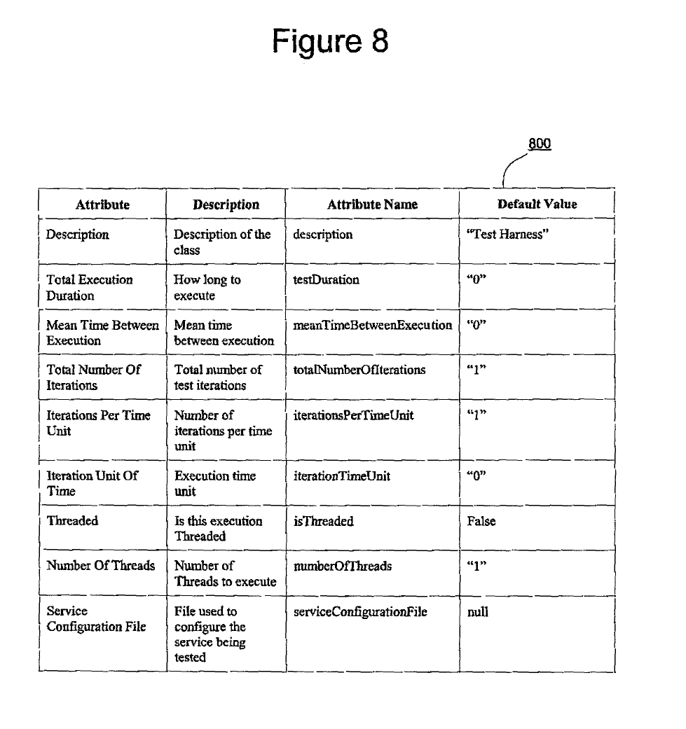

With reference next to FIG. 8, a diagram illustrating example attributes associated with a test harness is depicted in accordance with a preferred embodiment of the present invention. Table 800 illustrates different attributes associated with a test harness, such as test harness 500 in FIG. 5. These attributes identify different characteristics, which may be set within test harness 502 for testing different test cases. The values for these different attribute files may be specified in a configuration file containing the test case. The attributes illustrated in these figures are for purposes of explanation and relate to a particular implementation of the test harness. Attributes may be added or removed for different implementations of the test harness.

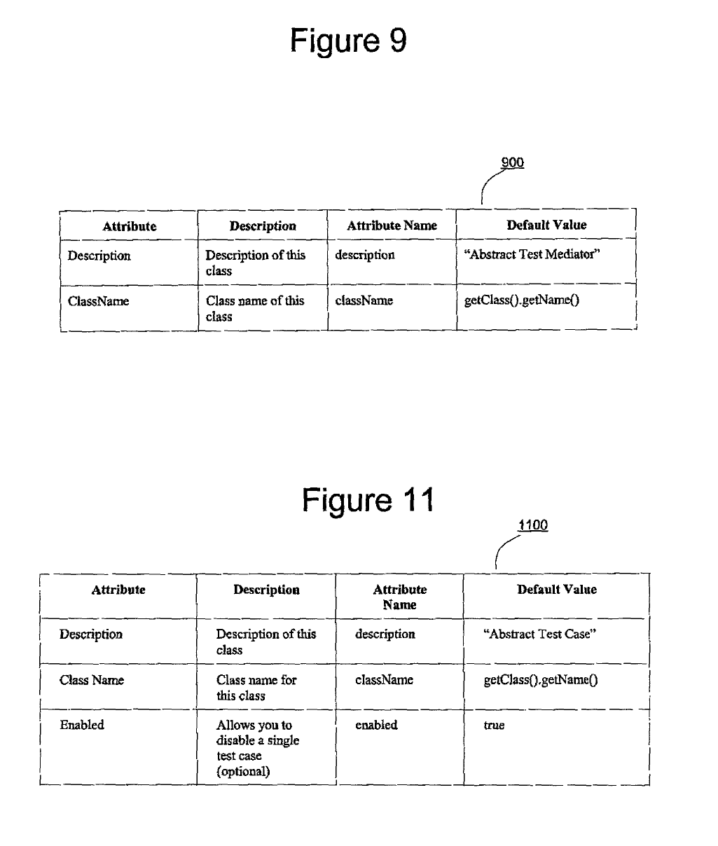

Turning next to FIG. 9, a diagram illustrating example attributes associated with an abstract test mediator is depicted in accordance with a preferred embodiment of the present invention. Table 900 illustrates different attributes associated with a test mediator, such as ITestMediator 504 in FIG. 5. These values also may be specified in a configuration file containing the test case. The attributes illustrated in these figures are for purposes of explanation and relate to a particular implementation of the test mediator. Attributes may be added or removed for different implementations of the test mediator.

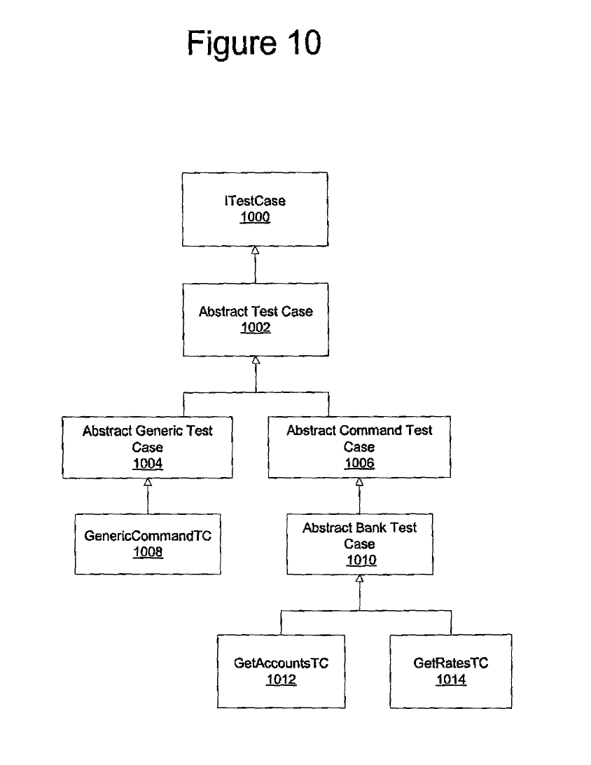

With reference next to FIG. 10, a diagram illustrating a hierarchy of test case classes is depicted in accordance with a preferred embodiment of the present invention. In this example, abstract test case 1002 is a specific instance of ItestCase 1000.

Abstract test case 1002 is a class, which is a super class of all test cases. This class must be extended to build a specific test case or a test case hierarchy for testing components. For example, a command test case hierarchy is built to test commands and a task test hierarchy is built to test tasks. In extending this class, these hierarchies contain specific code that understands how to handle and execute a specific component being tested. This class includes a configure method, which is invoked when a test case is initialized.

The configure method loads data from a configuration file describing the test case. Additionally, this class also includes an execute method. This method is invoked during testing harness execution and provides any logic required to execute a test on a target component. For example, when testing a command, the logic should include any record, manipulation, and execution for the command. This logic also may include any necessary exception handling.

In these examples, base implementations for several specific functions are provided in the abstract test case class. These functions can be used by subclasses and include the following: (1) configuring; (2) loading values from the test harness file; (3) recursively validating an element list against a hash table list; (4) recursively validating an element of an XML document; (5) validating two strings for equality; and (6) sorting sets of data.

The harness loads all configuration files, and caches them in an XML document (JDOM object(s)). This document is passed to the test cases and the test cases know how to parse the XML document based on the specific test case.

Abstract generic test case 1004 and abstract command test case 1006 are subclasses of abstract test case 1002 providing basic methods. Abstract generic test case 1004 is a class that must be extended by a developer for developing generic test cases for a component or a component set. In using this class, the developer provides an implementation for the component being tested that is reusable and configurable for that component. Abstract generic test case 1004 is configured through a configuration file, such as an XML file. This file allows a developer to specify and describe the component being tested. GenericCommandTC 1008 is a test case that understands how to handle all command types. A developer can describe a test case for any command type and the GenericCommandTC will know what to do. This means that for all commands within an application, a developer will never have to write another command test case.

Abstract bank test case 1010 is an example of a test case that tests bank commands. In this example, abstract bank test case 1010 is an extension of abstract command test case 1006. Subclasses of abstract bank test case include GetAccountsTC 1012 and GetRatesTC 1014.

Developers that wish to build a test case implementation for testing EAB commands would extend abstract test case 1002 to abstract command test case 1006. Abstract test case 1002 does not provide code for testing commands; abstract command test case 1006 does. Abstract command test case 1006 provides some infrastructure code for handling commands, such as, for example, loading all commands through a command manager. A command test case would need to understand and handle internals relating to commands. This could include populating input records, executing the command, comparing the input record and output records, and handling specific exceptions relating to commands. An implementation would be designed and implanted to ease the programming for the command developers. Developers would describe the test scenario for testing a specific command and invoke the testing framework.

Turning next to FIG. 11, a diagram illustrating example attributes for an abstract test case class is depicted in accordance with a preferred embodiment of the present invention. Attributes in table 1100 are examples of attributes, which may be defined by test cases.

With reference now to FIG. 12, a flowchart of a process for generating test code using a reflection function is depicted in accordance with a preferred embodiment of the present invention. This process is implemented as part of a test case in these examples. The code generation employs a built in facility of Java called “reflection”. Reflection allows Java objects to be automatically loaded and initialized at runtime based on configuration information. The objects are used during the lifetime of the framework execution, unless they are disposed of at some point. This code is not saved to a physical device. The process is initiated by the execution of a test case by a test mediator.

More specifically, the process begins with the test case parsing XML configuration information passed in by the test mediator (step 1200). This information may be passed in as a JDOM object. JDOM is a version of a document object model designed for Java. A document object model (DOM) provides a way of converting a textual XML type document into an object hierarchy, and applies across different programming languages. Next, the test case identifies objects necessary for this test case execution (step 1202). The test case then retrieves the object creation information from the configuration data, such as, for example, class names, package names, and data values (step 1204).

Thereafter, the test case creates and initializes necessary data objects (step 1206). The test case populates new data objects from configuration data (step 1208) with the test case completing execution thereafter. In this manner, the configuration data allows the reuse of test cases to test similar application components by changing the data object configurations necessary for the test case execution. As a result, every ‘Command’ type may be tested by only changing configuration information, because necessary objects are generated and populated as needed.

With reference now to FIG. 13, a flowchart of a process used for comparing test results is depicted in accordance with a preferred embodiment of the present invention. The process illustrated in FIG. 13 may be implemented in an abstract test case, such as abstract test case 510 in FIG. 5.

The process begins by parsing the actual results (step 1300). These actual results are the results returned from the test component. The parsing of the data that is to be compared may be identified by information in the configuration file. The data from the actual results is converted into a first hash table (step 1302). The expected results are parsed (step 1304). The description of this data also is described in the configuration file. The data from the expected results is converted into a second hash table (step 1306). The hash tables are then compared (step 1308).

Next, a determination is made as to whether there is a match between the values in the first and second hash table (step 1310). If there is a match between the first and second hash table, no error is returned (step 1312) and the process terminates thereafter. With reference again to step 1310, if there is not a match between the first and second hash table, an error is returned (step 1314) with the process terminating thereafter.

The following is an example of a configuration file for a test case in accordance with a preferred embodiment of the present invention:

<?xml version=“1.0” encoding=“UTF-8” ?>
<!-This indicates that there is a list of initialize service stanzas to follow-->
<initialize-services>

<!-The opening tag for a service stanza-->
<service-info>

<!-This tag indicates the fully qualified Class name for the service-->
<!-that needs to he loaded -->
<name>

com.company.infrastructure.connectivity.connector.CommandManagerWrapper

</name>
<!-This tag indicates the name of the properties file used for the -->
<!-service configuraiton -->
<properties-file>

c:/tmp/CommandManagerBANK.properties

</properties-file>

</service-info>

</initialize-services>
<!-- The opening tag of the Test Harness Framework. -->
<!-- Specifies that the following stanzas will describe -->
<!-- a testing framework exeution configuraion -->
<TestHarness

<!-- The description of the testing harness. -->
<!-- This is used for debugging purposes -->
description=“Bank Command Test Harness”
<!-- The duration of time the testing framework should be executing -->
<!-- This tells the framework to continue exeuting over and over for -->
<!-- specified amount of time -->
testDuration = “30000”
<!-- The mean time between execution. This is used to throttle the ->
<!-- exeution between each test case -->
meanTimeBetweenExecution = “1000”
<!-- The total number of executions -->
totalNumberOfIterations = “2”
<!-- The number of iterations per time unit. This is used for exeuting -->
<!-- a recommended number of exeutions during a specified time frame -->
iterationsPerTimeUnit = “100”
<!-- The time unit for a set number of iterations -->
iterationTimeUnit = “10000”
<!-- The flag that indicates if this exeution if to be threaded -->
isThreaded = “true”
<!-- The number of Threads used to exeute the test cases>
numberOfThreads = “2”
<!-- The configuration file name for the service being tested -->
serviceConfigurationFile = “c:/tmp/CommandManagerBANK.properties”>
<!-- The Opening tag for the Test Mediator stanza. The following stanza-->
<!-- describes the configuration for the test mediator -->
<TestMediator

<!-- The class name of the test mediator. This specifies what class to-->
<!-- load and instantiate for the test mediator. This is a fully -->
<!-- fully qualified name. If this name is ommited, an instance of the -->
<!-- AbstractTestMediator class will be used -->
className = “”
<!-- The description of the test mediator. This is used for debugging -->
description =“Test Mediator”>
<!-- The opening tag that indicates a list of test cases are to follow -->
<TestCases>

<!-- The opening tag that indicates a description of a test case -->
<!-- will follow -->
<TestCase

<!-- The class name of the test case to be executed. This -->
<!-- is the fully qualified class name of fot the test case class -->
className = “com.company.bank.conn.test.testharness.BeginIFSSessionTC”
<!-- The name of the command to be executed, as this is a test -->
<!-- to test commands, the command name is needed. -->
<!-- For other specific test cases, other attributes -->
<!-- would be specified -->
commandName = “com.company.bank.conn.commands.BeginIFSSessionCMD”
<!-- The description of the test case. This is used for debugging -->
description = “Begin Session Test Case”>
<!-- This opening tag indicates there will be data sets -->
<!-- followng that are to be used during the exeution of the -->
<!-- testing framework -->
<DataSets>
<!-- The opening tag that indicated there is a stanza -->
<!-- that defines a data set that will follow -->

<DataSet>
<!-- The opening tag that indicates there will be an
<!-- data input stanza that is used for input to the test case -->

<Input>

<!-The following tags are test case specific tags for data -->
<!-- used as input to the test case -->
<ServerName> L00012ER</ServerName>
<ClientId>00</ClientId>
<SessionId> 12345 </SessionId>
<COMPANYNumber>007041044</COMPANYNumber>
<EmployeeId>454545</EmployeeId>
<Pin>000000</Pin>
<Blocked>Y</Blocked>

</Input>
<!-- The opening tag that indicates there will be an -->
<!-- result data stanza that is used for comparing -->
<!-- results from the test case exeution -->
<Result>

<!-- The following tags are test case specific -->
<!-- tags for data used as results to the test case -->
<!-- notice this tag has a “cache” attribute. This -->
<!-- is used to indicate to the framework to cache -->
<!-- the result value for later use within the -->
<!-- test exeution -->

<SessionId cache=“true”>

00000000006B7014

</SessionId>

</Result>

</DataSet>

</DataSets>

</TestCase>

<!-- The following tags are here to show that more test cases -->
<!-- can he added and expanded -->

<TestCase>

<DataSets>

<DataSet>

<Input>

<Result>

//More stuff

</Result>

</Input>

</DataSet>

</DataSets>

</TestCase>

</TestCases>

</TestMediator>

</CommandTestHarness>

In these examples, the configuration file is an XML file. In this particular example, the configuration file is directed towards testing a bank GetAccountsTC command in FIG. 10. This configuration file includes values for parameters, such as those described in table 800, table 900, and table 1100.

Thus, the present invention provides an improved method, apparatus, and computer instructions for testing components. The mechanism of the present invention employs an application testing framework in which a reusable testing engine, a testing harness, is employed in testing applications and application services. With this reusable testing engine, many different components may be tested through the use of different configuration files describing parameters for testing the components.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for testing different types of software components, the method comprising:
reading a test case, wherein the test case includes configuration data to identify a selected software component from the different types of software components for testing and input data;
executing the selected software component identified by the configuration data using the input data, wherein an actual result is generated; and
comparing the actual result with an expected result.

2. The method of claim 1, wherein the test case data is read from a configuration file.

3. The method of claim 1, wherein the configuration file is an extensible markup language file.

4. The method of claim 1, wherein the comparing step comprises:
generating a first hash table from the actual result;
generating a second hash table from the expected result; and
comparing the first hash table with the second hash table.

5. The method of claim 1, wherein the reading, executing, and comparing steps are repeated for other software components from the different types of software components.

6. The method of claim 1, wherein the comparing step forms a comparison and further comprising:
presenting the comparison.

7. The method of claim 2, wherein the selected software component is one of a Java method, an application programming interface, or a business function.

8. The method of claim 1 further comprising:
generating code specific to the selected component based on the configuration data, wherien the code is used in executing the selected software component.

9. The method of claim 8, wherein the selected component is a Java component and wherein the generating step generates the code using introspection.

10. A data processing system comprising:
a bus system;
a communications unit connected to the bus system;
a memory connected to the bus system, wherein the memory includes a set of instructions; and
a processing unit connected to the bus system, wherein the processing unit executes the set of instructions to read a test case in which the test case includes configuration data to identify a selected software component from a set of different types of software components for testing and input data; execute the selected software component identified by the configuration data using the input data in which an actual result is generated; and compare the actual result with an expected result.

11. A data processing system for testing different types of software software components software, the data processing system comprising:
reading means for reading a test case, wherein the test case includes configuration data to identify a selected software component from the different types of software components for testing and input data;
executing means for executing the selected software component identified by the configuration data using the input data, wherein an actual result is generated; and
comparing means for comparing the actual result with an expected result.

12. The data processing system of claim 11, wherein the test case data is read from a configuration file.

13. The data processing system of claim 11, wherein the configuration file is an extensible markup language file.

14. The data processing system of claim 11, wherein the comparing means comprises:
first generating means for generating a first hash table from the actual result;
second generating means for generating a second hash table from the expected result; and
comparing means for comparing the first hash table with the second hash table.

15. The data processing system of claim 11, wherein the reading means, executing means, and comparing means are reinvoked for other test cases.

16. The data processing system of claim 11, wherein the comparing means generates a comparison and further comprising:
presenting means for presenting the comparison.

17. The data processing system of claim 12, wherein the selected software component is one of a Java method, an application programming interface, or a business function.

18. The data processing system of claim 11 further comprising:
generating means for generating code specific to the selected component based on the configuration data, wherien the code is used in executing the selected software component.

19. The data processing system of claim 18, wherein the selected component is a Java component and wherein the generating means generates the code using introspection.

20. A computer program product in a computer readable medium for testing for testing different types of software software components, the computer program product comprising:
first instructions for reading a test case, wherein the test case includes configuration data to identify a selected software component from the different types of software components for testing and input data;
second instructions for executing the selected software component identified by the configuration data using the input data, wherein an actual result is generated; and
third instructions for comparing the actual result with an expected result.
